(19) United States
(12) Patent Application Publication
(10) Pub. No.: US 2025/0190554 A1
(43) Pub. Date: Jun. 12, 2025

(54) PREVENTING UNAUTHORIZED ACCESS TO DEVICE LOCATION

(71) Applicant: Apple Inc., Cupertino, CA (US)

(72) Inventors: Siva Ganesh Movva, San Jose, CA (US); Alexander R. Hanuska, Campbell, CA (US); Emmanuel Lalande, Lachine (CA); Mikhail Z. Ameerally, Campbell, CA (US); Sureshkumar T. Rathi, Cupertino, CA (US)

(73) Assignee: Apple Inc., Cupertino, CA (US)

(21) Appl. No.: 18/976,142

(22) Filed: Dec. 10, 2024

Related U.S. Application Data
(60) Provisional application No. 63/608,285, filed on Dec. 10, 2023.

(51) Int. Cl. G06F 21/55

(52) U.S. Cl. CPC G06F 21/554; G06F 2221/034

(57) ABSTRACT

Techniques for preventing unauthorized device location information are described herein. A service running on a server devices can receive, from a set of user devices associated with a profile, respective user device tracking information for each device. The set of user devices can include trusted devices and untrusted devices. The service can receive a first signal that a critical operation associated with the profile is being requested. The service can receive, from a first user device of the set of one or more user devices, a request for respective user device tracking information for other devices. The service can determine whether the first user device is untrusted. In accordance with a determination that the first user device is untrusted, the service can determine to not transmit respective user device tracking information for other devices to the first user device.

### CROSS-REFERENCES TO RELATED APPLICATIONS

This application claims the benefit of U.S. Provisional Application No. 63/608,285, filed on Dec. 10, 2023, which is incorporated by reference.

### BACKGROUND

Mobile electronic devices are becoming ubiquitous. Users want to be able to use device location services from their mobile devices. However, users also want to prevent bad actors who have stolen or taken their mobile devices from accessing device location services.

### DESCRIPTION OF THE DRAWINGS

FIG. 1 illustrates a diagram for explaining techniques related to generating authorized locations, according to at least one example.

FIG. 2 illustrates a diagram for explaining techniques related to generating authorized locations, according to at least one example.

FIG. 3 illustrates an example flow diagram for techniques related to generating authorized locations, according to at least one example.

FIG. 4 illustrates a diagram for explaining techniques related to determining a user device is located at an authorized locations, according to at least one example.

FIG. 5 illustrates an example flow diagram for techniques related determining a user device is located at an authorized locations, according to at least one example.

FIG. 6 illustrates an example architecture or environment configured to implement techniques relating to authorized locations, according to at least one example.

### DETAILED DESCRIPTION

Certain embodiments of the present disclosure relate to techniques (e.g., systems, devices, computer-readable medium, and/or methods) for implementing various features for preventing unauthorized access to device location services. In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, techniques for protecting user accounts related to device location services from malicious activity. For example, the techniques described herein can be used to prevent unauthorized access to device location services. The techniques described herein relate to device location-related techniques across multiple devices, including multiple types of devices, associated with a single profile (e.g., a single user account used on each of the multiple devices). Example devices can include smartphones, smartwatches, laptops, computing devices, or any electronic user device. Users can use device location services to access device location information in order to find lost or misplaced devices associated with an account. Users can also use device location services on devices associated with the account to initiate remote security features if a device cannot be found (for example, if a thief or adversary takes the device from a user) such as initiating a remote wipe to remove personal information from the device. However, the use of device location services also involves privacy concerns such that users must opt-in to the device location services knowing that the device location may be constantly or periodically monitored. However, if an adversary gains control of a particular device and is able to access the associated account, the adversary may be able to use the device location services to track other devices on the account. The adversary may also remove the particular device from the account, thus thwarting the use of device location services including both device location information and the use of remote security features.

In one example, the techniques described herein limit and/or prevent unauthorized access (for example, access by an adversary) to device location services associated with an account while minimizing potential barriers to the user (for example, the owner of the device) in accessing device location services. Device location services can be hosted on servers which can be accessed through a network (such as the Internet). Device location services can include access to device location information for devices associated with an account. An account can be associated with one or more devices. Device location information can be used to determine a present location of a user device or a last known location of a user device. Device location services can be accessed via account credentials such as a username and password. Device location services can be accessed by devices associated with the account, but also through a web-based service (for example, a web browser).

Device location services can be useful when a valid user (also referred to as an authenticated user or an authorized user) has access, but device location services have been used by adversaries for undesirable uses. In particular, some adversaries may have access to the account via account credentials (either by previously knowing or determining the account credentials, for example, from hacking the user device). With access to the account, an adversary may be able to track other devices associated with the account via the device location services. In some examples, the adversary is able to log into the account on the web-based service.

Limiting and/or preventing unauthorized access to device location services can be achieved through the use of trusted and untrusted devices. Trusted devices are devices which can verify that an authorized user is using the device via multi-factor authentication. For example, a trusted device can have a facial recognition biometric authentication service or a fingerprint identification biometric authentication service that is tied to an authorized user as a second factor for multi-factor authentication (the first factor being user credentials such as a username and password). Untrusted devices are devices that are unable to provide multi-factor authentication (for example, a second factor of multifactor authentication). For example, an untrusted device may not be able verify that an authorized user is using the device via biometric authentication services. Untrusted devices can include devices that do not have biometric authentication services or devices where those services are disabled or nonfunctional. For example, accessing device location services via a web-based service (for example, a web browser) may not be able to provide biometric authentication services such that the web-based service is considered an untrusted device. Untrusted devices can also include devices that have biometric authentication services (or other multi-factor authentication services), but are unable to use the biometric authentication services (or other factors for multi-factor authentication) to verify that an authorized user is using the device. For example, the biometric authentication services may be dysfunctional or non-functional. In another example, the device may attempt to use biometric authentication services, but a current user does not match the biometrics on the device (for example, an adversary).

The concept of trusted and untrusted devices can be used to establish if an authorized user is requesting performance of device location service operations. When a device requests performance of certain device location service operations, the device location services can operate differently based on whether the device is trusted or untrusted. Prior to performing the device location service operations, the device location services can request biometric authentication from a present user of the device. If the device is able to confirm biometric authentication, the device location services can determine that the device is trusted. If the device is unable to confirm biometric authentication, the device location services can determine the device is untrusted. It should also be understood that a device may be considered untrusted (based on the above criteria) even if a user has properly logged into the device (e.g., using the passkey or a password). Although the specifics depend on the device location service operations, generally if an untrusted device requests performance of device location service operations, the device location service operations may not be performed under certain conditions.

In one example, a first device may request that a second device (either the same first device or a different device) be removed from the account and thus disabling device location services related to the second device. If the first device is trusted, then the device location services may remove the second device from the account. If the first device is untrusted, the device location services may perform one or more different operations. In one example operation, the device location services may maintain the second device on the account for a first cooldown period, after which the second device is removed from the account. In another example operation, the device location services may maintain the second device on the account but prevent untrusted devices from accessing device location services related to the second device. Meanwhile, trusted devices are still able to access device location services (for example, device location information and remote security features) related to the second device. In this way, the second device may appear to be removed from the account to untrusted devices although the second device is not actually removed from the account. These operations allow an authorized user to remove the second device from the account, but protect against an adversary from removing the second device from the account. Thus, the authorized user can initiate a remote wipe on the second device during the first cooldown period.

In another example, the device location services may receive one or more signals indicating that a critical operation related to the account is occurring. In some examples, a critical operation can be identifying a device of the account as lost or changing a password associated with the account. If a signal indicates that a critical operation is occurring in relation to an account, some device location service operations may be performed differently based on whether an untrusted or a trusted device is requesting the device location service operations. For example, if a trusted device is requesting the device location service operations, then the device location services may perform the device location service operations. In another example, an untrusted device may request device location information for the devices associated with an account while a critical operation is occurring. The device location services may ignore the request and/or respond that device location information is unavailable or unknown. Alternatively, the device location services may present false device location information that appears to be valid.

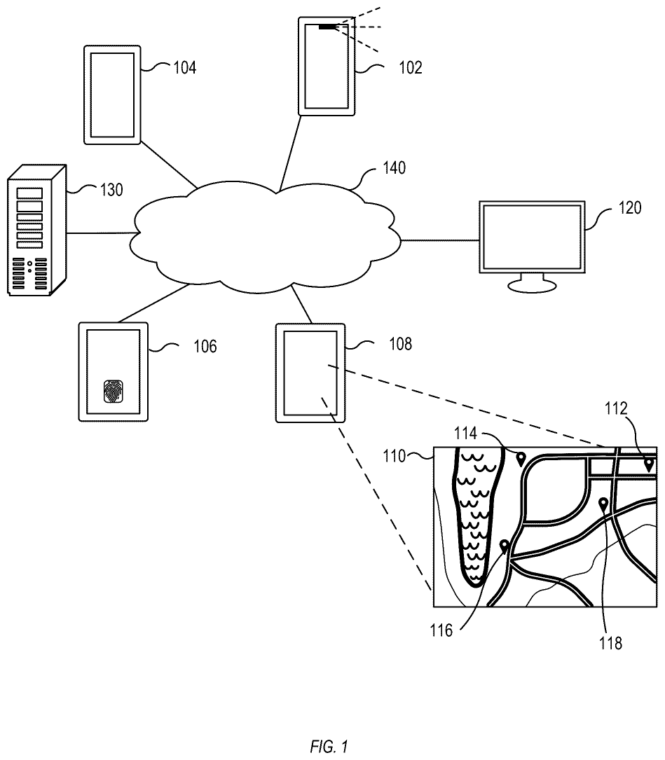

FIG. 1 illustrates an example diagram of devices related to the techniques of preventing unauthorized access to device location services described herein. An account can be associated with devices 102, 104, 106, 108. The account can be accessed via account credentials (for example, a username and password). The account can include device location services which are hosted on (for example, performed by or operated by) server 130. In some examples, the device location services can be hosted on one or more servers. Devices 102, 104, 106, 108 are able to access device location services for the account. For example, devices 102, 104, 106, 108 can be used to present (e.g., on their respective displays) device locations 112, 114, 116, 118 corresponding, respectively, to devices 102, 104, 106, 108 on a map 110. The device locations 112, 114, 116, 118 can be provided to devices 102, 104, 106, 108 from the device location services. The device location services can periodically request and/or receive device locations for devices 102, 104, 106, 108. The device location services can request and receive device locations on a best-effort basis. In some examples, one or more of device locations 112, 114, 116, 118 can be a last known device location. A last known device location may be associated with a time where the device location was verified, but the device location services are unable to query the corresponding device for a current location. Web-based service 120 can also be used to access device location services associated with the account via account credentials. Devices 102, 104, 106, 108, server 130, and web-based service 120 can be connected via a network 140. The network 140 can be a local area network (LAN), wide area network (WAN), and any combination of LAN and WAN (for example, the Internet).

When device location service operations are requested by devices 102, 104, 106, 108, the device location services can determine whether the requesting device is trusted or untrusted. Trusted devices can have multi-factor authentication functionality that can confirm that a current user of the device is an authorized user. For example, trusted devices may have biometric authentication functionality that can confirm that a current user is the device is an authorized user. In some examples, authorized users are established on the account level such that authorized users can confirm authorized status on any device with multi-factor authentication services (for example, biometric authentication services). In some examples, authorized users are established on a device level such that each device can have one or more authorized users that are not necessarily shared across the account. In some examples, an authorized user can be registered at a device level for each device but an account can only be associated with a limited number of authorized users. In some examples, authorized users can be the owner of the device. In some examples, an account or a device can only have one authorized user. As illustrated in FIG. 1, device 102 can have biometric authentication functionality such as facial recognition. Similarly, device 106 can have biometric authentication functionality such as fingerprint identification. In some examples, the device location services may only accept certain multi-factor authentication functionality and settings for establishing whether a device is trusted or untrusted. For example, the device location services may only accept facial recognition biometric authentication from certain combinations of software and/or hardware (including version numbers) for establishing a device as trusted. In FIG. 1, devices 104, 108 are devices without biometric authentication functionality. Similarly, accessing device location services via a web-based service 120 may not be able to provide biometric authentication for a current user. Thus, device location services can determine that the device 104, 108 and web-based service 120 are untrusted. As described herein, Untrusted devices are devices that are unable to provide multi-factor authentication (for example, a second factor of multifactor authentication). For example, an untrusted device may not be able verify that an authorized user is using the device via biometric authentication services. This application describes biometric authentication as the primary second factor in multi-factor authentication, but any second factor of multi-factor authentication can be used to determine if a device is trusted or untrusted.

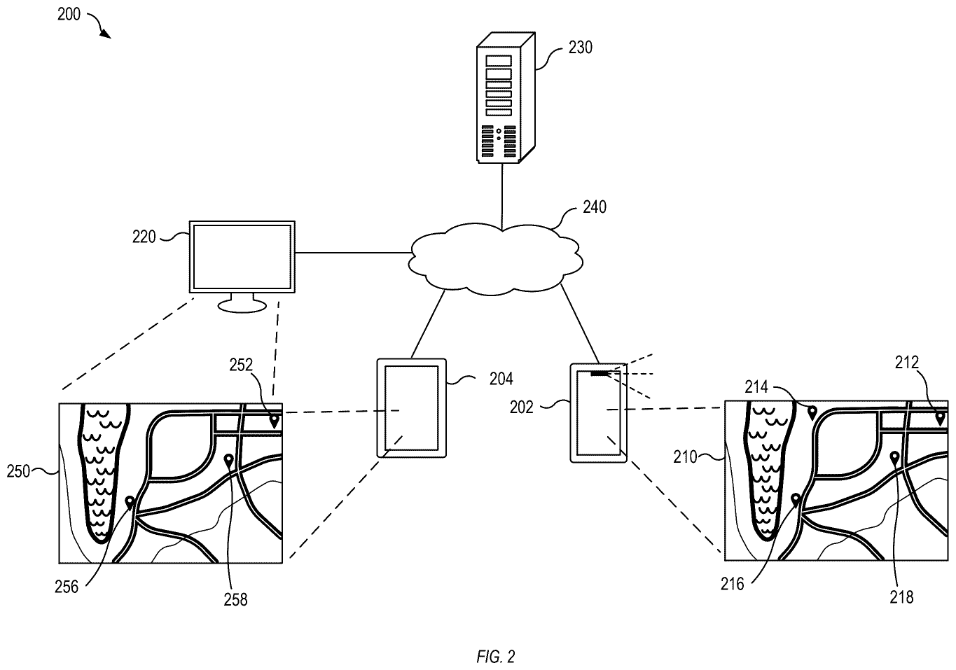

FIG. 2 illustrates an example diagram of devices related to the techniques of preventing unauthorized access to device location services described herein. An account can be associated with four devices. The first device 202 (for example, the device 102 of FIG. 1) can be a device with biometric authentication functionality. In some examples, the second device 204 can be a device without biometric authentication, such as the device 104 of FIG. 1. In some examples, the second device 204 has biometric authentication functionality, but is unable to receive biometric authentication from an authenticated user (for example, the current user is not an authenticated user or the biometric authentication functionality is nonfunctional). Two additional devices are not shown in the figure. The account can be accessed via account credentials (for example, a username and password). The account can include device location services which are hosted on (for example, performed by or operated by) server 230 (for example, server 130 of FIG. 1). In some examples, the device location services can be hosted on one or more servers. The account and corresponding device location services can also be accessed via a web-based service 220 (for example, web-based service 120). The first device 202, the second device 204, server 230, and web-based service 220 can be connected via a network 240 (for example, the network 140 of FIG. 1). The network 240 can be a local area network (LAN), wide area network (WAN), and any combination of LAN and WAN (for example, the Internet).

Prior to a request for removing a device from the account and/or device location services, the first device 202, the second device 204, and the web-based service 220 can request the device locations 212, 214, 216, 218 corresponding, respectively, to the first device 202, the second device 204, and the two devices not shown in the figure on map 210. The device locations 212, 214, 216, 218 can be provided to the first device 202, the second device 204, and the web-based service 220 from the device location services.

At a later time, the second device 204 can transmit an operational request to remove the second device 204 from the account and/or from device location services associated with the account. In this example, the second device 204 is unable to provide biometric authentication because of any of the following situations: biometric functionality is unavailable or nonfunction or the biometrics of a current user did not match the biometrics of an authorized user (for example, the current user is an adversary or other non-authorized user). In some examples, the operational request can include an indication that biometric authentication confirming that an authorized user authorized the request was not received by the second device 204 (either because the second device 204 lacks biometric authentication functionality or the biometrics of a current user did not match the stored biometrics). An indication that biometric authentication confirming that an authorized user authorized the request was not received can be referred to as a negative biometric authentication indication. In these example, the device location services receive the operational request, the device location services can determine the second device 204 is untrusted based on the request from the second device 204. In some examples, the device location services can receive the operational request without an indication that biometric authentication confirming that an authorized user authorized the request was not received by the second device 204. In these examples, the device location services can send a biometric authorization request to the second device 204 requesting that the second device 204 perform biometric authentication confirming that an authorized user authorized the operational request. The second device 204 transmit a biometric authorization response to the device location services with a negative biometric authentication indication.

Although the operational request to remove the second device 204 from the account and/or from device locations originates from an untrusted device, the device location services may not be able to ascertain why the second device 204 is an untrusted device. As such, the device location services may need to perform the operational request in a way that balances the requests of an authorized user. For example, if an adversary is attempting to remove the second device 204 from the account and/or from device locations, the adversary is attempting to prevent an authorized user from tracking the second device 204 or initiating remote security functions such as remote wipe on the second device 204. However, if the biometric authentication of the second device 204 is nonfunctional and an authorized user (if using a device with functional biometric authentication) attempts to remove the second device 204 from the account and/or from device locations, the removal is proper.

Thus, the device location services put the second device 204 onto a “pending removal” list. A device on the “pending removal” list can have a “pending removal” status for a first time period (for example, 7, 15, 30, 60, or any number of days, or other appropriate time period). The device remains on the “pending removal” list until the first time period elapses. Untrusted devices will not then be able to access the second device 204 via device location services. Untrusted devices (for example, the web-based service 220 and the second device 204) are unable to request the location of the second device 204 on the map 250 or initiate performance of remote security operations on the second device 204. However, the second device 204 may be able to request the device locations 252, 256, 258 corresponding to the first device 202 and the other two devices not pictured. Furthermore, the untrusted devices may not be able to see that the second device 204 has been moved to a “pending removal” list. A similar outcome would occur if the operational request to remove the second device 204 from the account and/or from device location services associated with the account originated from another untrusted device such as the web-based service 220.

On the other hand, trusted devices (for example, the first device 202) are able to view the devices on the “pending removal” list. Trusted devices can also request the location and initiate performance of remote security operations on devices on the “pending removal” list. For example, the first device 202 may be able to request the device locations 212, 214, 216, 218 corresponding to the first device 202, the second device 204, and the other two devices not pictured on the map 210. In this way, an authorized user can still access device location services related to the second device 204 if the request to remove the second device 204 originated from an untrusted device.

In some examples, if a trusted device requested that the second device 204 be removed from the account and/or from device location services associated with the account, the device location services may not move the second device 204 to the “pending removal” list. In some examples, if a trusted device requested that the second device 204 be removed from the account and/or from device location services associated with the account, the device location services may move the second device 204 to the “pending removal” list, but for a second time period shorter than the first time period (for example, 1, 3, 5, 7, 15, or any number of days or other appropriate time period).

In some examples, the use of the “pending removal” list and the “pending removal” state can be used without needing to determine whether devices are trusted or untrusted. For example, when a device (untrusted or untrusted) is removed from the account and no longer has access to the account (and the locations of other devices), the removed device can be added to the “pending removal” list for the account for a duration of any time period described herein. Other devices that have access to the account can still request device location services related to the removed device while the removed device is on the “pending removal” list. For example, devices that have access to the account can still request the location of the removed device and/or initiate a remote wipe of the removed device.

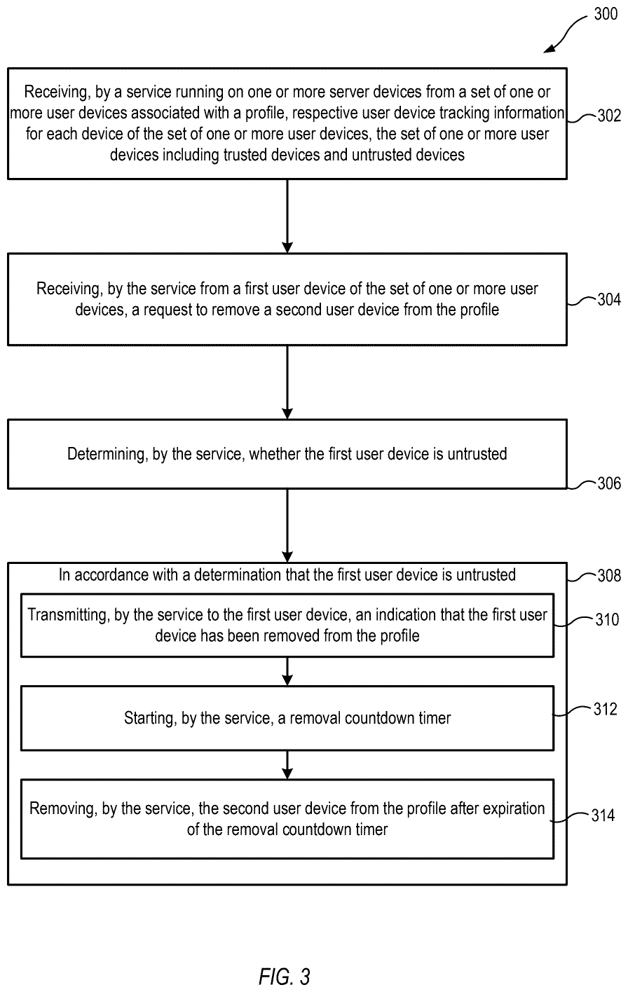

FIG. 3 illustrates an example process 300 for preventing unauthorized removal of a device from a profile as described herein (for example, as described in relation to FIG. 2). As described herein, device location information can be referred to as device location data, device tracking information, and device tracking data. Example process 300 can be implemented on a server (for example, server 130 of FIG. 1) running device location services.

At block 302, a service (for example, device location services), running on one or more server devices (for example, server 130 of FIG. 1), can receive, from a set of one or more user associated with a profile, respective user device tracking information for each device of the set of one or more user devices. The set of one or more user devices can include trusted devices and untrusted devices. The respective user device tracking information for the one or more devices can be accessible by a web browser.

At block 304, the service can receive, from a first user device of the set of one or more user devices, a request to remove a second user device from the profile. The request to remove a second user device from the profile can include an indication that biometric confirmation was not received by the first user device in association with the request for respective user device tracking information for other devices.

At block 306, the service can determine whether the first user device is untrusted. Determining whether the first user device is untrusted can include the service determining whether the request originates from a web browser on the first user device. In accordance with determining the request originates from the web browser, the service can determine the first user device is untrusted. Determining whether the first user device is untrusted can be based at least in part on an indication that the first user device did not receive biometric authentication in response to a biometric confirmation request from the service. Determining whether the first user device is untrusted can include the service transmitting, to the first user device, the biometric confirmation request. The first user device can be configured to request biometric authentication in response to the biometric confirmation request. Determining whether the first user device is untrusted can include the service receiving, from the first user device, the indication that the first user device did not receive biometric authentication in response to the biometric confirmation request. Determining whether the first user device is untrusted is based at least in part on the indication that biometric confirmation was not received by the first user device in association with the request for respective user device tracking information for other devices.

At block 308, the service can perform operations in accordance with a determination that the first user device is untrusted. For example, the operations can include the operations described in relation to block 310, 312, and 314. At block 310, the service can transmit, to the first user device, an indication that the first user device has been removed from the profile.

At block 312, the service can start a removal countdown timer. At block 314, the service can remove the second user device from the profile after expiration of the removal countdown timer.

The process 300 can further include the service receiving, from a third user device of the set of one or more user devices, prior to the expiration of the removal countdown timer, a request to reset the first user device and wipe all memories of the first user device. The process 300 can further include the service transmitting, to the first user device, instructions configured to cause the first user device to reset the first user device and wipe all memories of the first user device. The process 300 can further include the service receiving, from a third user device of the set of one or more user devices, prior to the expiration of the removal countdown timer, a request for the service to mark the first user device as a lost device. The process 300 can further include the service receiving, from the first user device, a connection request. The process 300 can further include the service transmitting, to the first user device, instructions configured to cause the first user device to enter a locked state that requires biometric authentication associated with the profile to unlock the first user device from the locked state.

The process 300 can further include the service receiving, from a third user device of the set of one or more user devices, prior to the expiration of the removal countdown timer, a request for the service to mark the first user device as a lost device. The process 300 can further include the service receiving, from a second service, connection information for the first user device. The second service can have received a connection request from the first user device. The process 300 can further include the service transmitting, to the first user device based at least on the connection information, instructions configured to cause the first user device to enter a locked state that requires biometric authentication associated with the profile to unlock the first user device from the locked state.

The process 300 can further include the service receiving, from a third user device of the set of one or more user devices, prior to the expiration of the removal countdown timer, a request for user device tracking information associated with the first user device. The process 300 can further include the service transmitting, to the third user device, user device tracking information associated with the first user device.

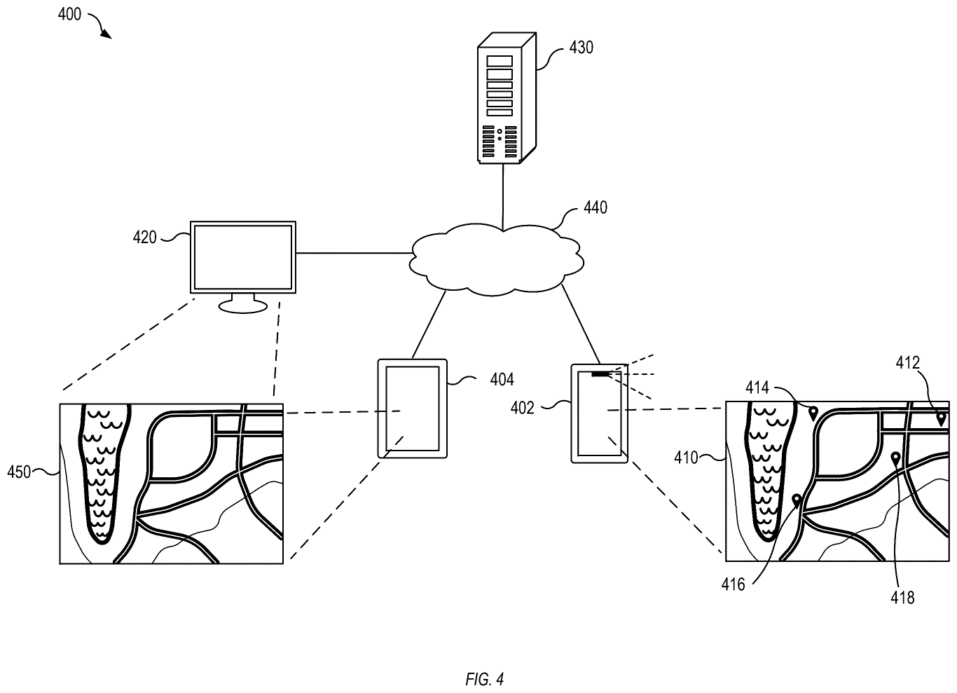

FIG. 4 illustrates an example diagram of devices related to the techniques of preventing unauthorized access to device location services described herein. An account can be associated with four devices. The first device 402 (for example, the device 102 of FIG. 1) can be a device with biometric authentication functionality. In some examples, the second device 404 can be a device without biometric authentication, such as the device 104 of FIG. 1. In some examples, the second device 404 has biometric authentication functionality, but is unable to receive biometric authentication from an authenticated user (for example, the current user is not an authenticated user or the biometric authentication functionality is nonfunctional). Two additional devices are not shown in the figure. The account can be accessed via account credentials (for example, a username and password). The account can include device location services which are hosted on (for example, performed by or operated by) server 430 (for example, server 130 of FIG. 1). In some examples, the device location services can be hosted on one or more servers. The account and corresponding device location services can also be accessed via a web-based service 420 that is accessible from a web browser (for example, web-based service 120). The first device 402, the second device 404, server 430, and web-based service 420 can be connected via a network 440 (for example, the network 140 of FIG. 1). The network 440 can be a local area network (LAN), wide area network (WAN), and any combination of LAN and WAN (for example, the Internet).

Prior to the device location services receiving one or more signals indicating a critical operation is occurring, the first device 402, the second device 404, and the web-based service 420 can be used to see device locations 412, 414, 416, 418 corresponding, respectively, to the first device 402, the second device 404, and the two devices not shown in the figure on map 410. The device locations 412, 414, 416, 418 can be provided to the first device 402, the second device 404, and the web-based service 420 from the device location services.

At a later time, one or more signals can indicate that a critical operation is occurring. Critical operations can include changing a username of the account, changing a password of the account, and marking a device associated with the account as a lost device. At a later time, one or more signals can indicate that the critical operation has ended. Oftentimes these critical operations occur when there is some kind of security threat. For example, marking a device as lost indicates that potentially an adversary could have the device. Similarly, changing a password may indicate that an adversary has access to the account. As such, additional security protections can be applied to device location services to prevent unauthorized use of device location services. In some examples, the one or more signals indicating a critical operation is occurring may be associated with an operation duration such as changing a username or password of an account. In some examples, the one or more signals indicating a critical operation is occurring are flags that indicate a status such as a device is lost.

As long as the critical operation is occurring, untrusted devices may not have access to device location services. For example, the second device 404 can transmit a location request to the device location services requesting the location of the first device 402. In this example, the second device 404 is unable to provide biometric authentication because of any of the following situations: biometric functionality is unavailable or nonfunction or the biometrics of a current user did not match the biometrics of an authorized user (for example, the current user is an adversary or other non-authorized user). In some examples, the location request can include an indication that biometric authentication confirming that an authorized user authorized the request was not received by the second device 404 (either because the second device 404 lacks biometric authentication functionality or the biometrics of a current user did not match the stored biometrics). An indication that biometric authentication confirming that an authorized user authorized the request was not received can be referred to as a negative biometric authentication indication. In these example, the device location services receive the location request, the device location services can determine the second device 404 is untrusted based on the request from the second device 404. In some examples, the device location services can receive the location request without an indication that biometric authentication confirming that an authorized user authorized the request was not received by the second device 404. In these examples, the device location services can send a biometric authorization request to the second device 404 requesting that the second device 404 perform biometric authentication confirming that an authorized user authorized the operational request. The second device 404 transmit a biometric authorization response to the device location services with a negative biometric authentication indication.

Although the location request for the first device 402 originates from an untrusted device, the device location services may not be able to ascertain why the second device 404 is an untrusted device. As such, the device location services may need to perform the operational request in a way that balances the requests of an authorized user. For example, preventing an adversary from accessing location information for other devices associated with the profile can be extremely important. However, if the biometric authentication of the second device 404 is nonfunctional, an authorized user can usually wait for the one or more signals indicating a critical operation is occurring to end.

While one or more signals indicate a critical operation is occurring, untrusted devices (for example, the web-based service 420 and the second device 404) are unable to request the location of any device, as shown on the map 450 or initiate performance of remote security operations on any device. In some examples, the untrusted devices can send a request for the location of any other device associated with the account, but the device locations services may determine to not transmit location data (for example, user device tracking information) for other devices to the untrusted devices. In some examples, the untrusted devices can send a request for the location of any other device associated with the account, but the device locations services may transmit a response that the location data for the other devices is unavailable or unknown. A response that the device location data for the other devices is unavailable or unknown may cause an adversary that has access to the untrusted device to not realize that a rightful owner of the device is aware the device is lost or missing. This may be helpful in locating the lost device. On the other hand, trusted devices (for example, the first device 402) are able to request the location and initiate performance of remote security operations on any device associated with the account. For example, the first device 202 may be able to request the device locations 412, 414, 416, 418 corresponding to the first device 402, the second device 404, and the other two devices not pictured as seen on the map 410. In this way, an authorized user can still access device location services while one or more signals indicate a critical operation is occurring.

In some examples, if a user device is marked as lost, the user device can be removed from a list of trusted device. For example, if the user device is marked as lost, the user device may not be able to become a trusted device until the user device is no longer marked as lost. In some examples, if a user device is marked as lost, the user device can be moved to a list of untrusted devices. For example, if the user device is marked as lost, the user device may not be able to become a trusted device until the user device is no longer marked as lost.

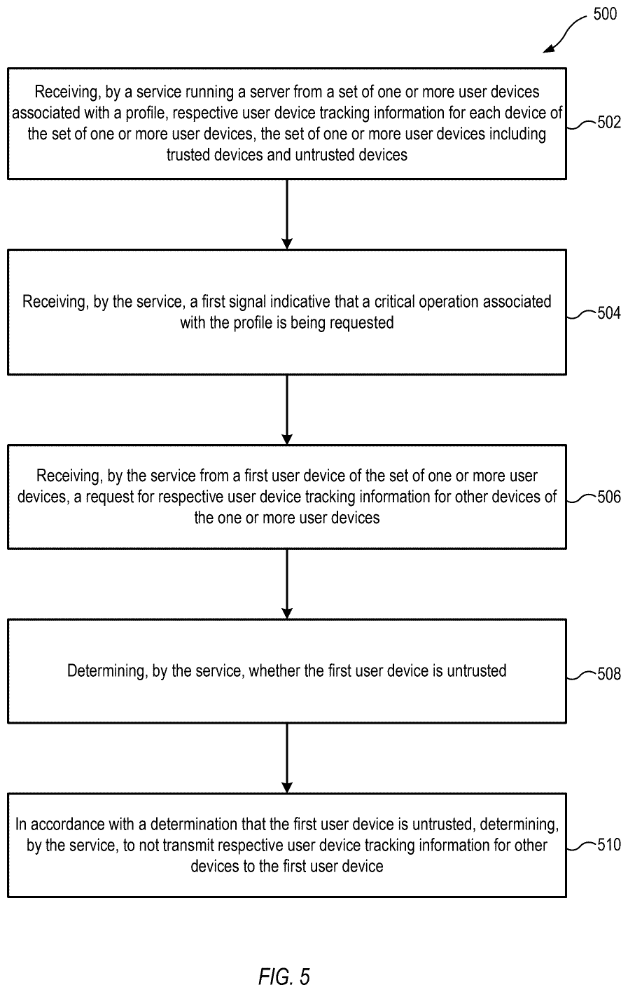

FIG. 5 illustrates an example process 500 for preventing unauthorized access to device location information as described herein (for example, as described in relation to FIG. 4). As described herein, device location information can be referred to as device location data, device tracking information, and device tracking data. Example process 500 can be implemented on a server (for example, server 130 of FIG. 1) running device location services.

At block 502, a service (for example, device location services), running on one or more server devices (for example, server 130 of FIG. 1), can receive, from a set of one or more user associated with a profile, respective user device tracking information for each device of the set of one or more user devices. The set of one or more user devices including trusted devices and untrusted devices. The respective user device tracking information for the one or more devices can be accessible by a web browser.

At block 504, the service can receive a first signal indicative that a critical operation associated with the profile is being requested. The critical operation can include altering a security feature associated with the profile. The critical operation can include accessing financial information associated with the profile. The critical operation can include marking a second user device as a lost device.

At block 506, the service can receive, from a first user device of the set of one or more user devices, a request for respective user device tracking information for other devices of the one or more user devices. The request for respective user device tracking information for other devices can include an indication that biometric confirmation was not received by the first user device in association with the request for respective user device tracking information for other devices.

At block 508, the service can determine whether the first user device is untrusted. Determining whether the first user device is untrusted can include the service determining whether the request originates from a web browser on the first user device. In accordance with determining the request originates from the web browser, the service can determine the first user device is untrusted. Determining whether the first user device is untrusted can be based at least in part on an indication that the first user device did not receive biometric authentication in response to a biometric confirmation request from the service. Determining whether the first user device is untrusted can include the service transmitting, to the first user device, the biometric confirmation request. The first user device can be configured to request biometric authentication in response to the biometric confirmation request. Determining whether the first user device is untrusted can include receiving, by the service from the first user device, the indication that the first user device did not receive biometric authentication in response to the biometric confirmation request. Determining whether the first user device is untrusted is based at least in part on the indication that biometric confirmation was not received by the first user device in association with the request for respective user device tracking information for other devices.

At block 510, the service, in accordance with a determination that the first user device is untrusted, can determine to not transmit respective user device tracking information for other devices to the first user device. Alternatively, the service, in accordance with a determination that the first user device is untrusted, can transmit an indication that the respective user device tracking information for other devices is unknown or unavailable based at least in part on the first signal.

The process 500 can further include the service determining whether the first user device is trusted. In accordance with determining the first user device is trusted, the service can transmit, to the first user device, respective user device tracking information for other devices of the one or more user devices. Determining whether the first user device is trusted can be based at least in part on an indication that the first user device received biometric authentication in response to a biometric confirmation request from the service. Determining whether the first user device is trusted can include the service transmitting, to the first user device, the biometric confirmation request. The first user device can be configured to request biometric authentication in response to the biometric confirmation request. Determining whether the first user device is trusted can include the service receiving, from the first user device, the indication that the first user device received biometric authentication in response to the biometric confirmation request. The request for respective user device tracking information for other devices of the one or more user devices can include a biometric confirmation that the first user device requested and received biometric authentication in association with the request for respective user device tracking information for other devices. Determining whether the first user device is trusted is based at least in part on the biometric confirmation that the first user device requested and received biometric authentication in association with the request for respective user device tracking information for other devices.

The process 500 can further include the service receiving a second request for respective user device tracking information for the one or more user devices. The service can determine whether the second request originates from a web browser. In accordance with determining the second request originates from the web browser, the service can transmit, to the first user device, an indication that the respective user device tracking information for other devices is unknown or unavailable based at least in part on the first signal. Alternatively, in accordance with determining the second request originates from the web browser, the service can determine to not transmit respective user device tracking information for other devices to the first user device.

The process 500 can further include the service receiving a second signal indicative that the critical operation is completed. After receiving the second signal, the service can receive, from the first user device, a request for respective user device tracking information for other devices of the one or more user devices. The service can transmit, to the first user device, respective user device tracking information for other devices of the one or more user devices based at least in part on the second signal.

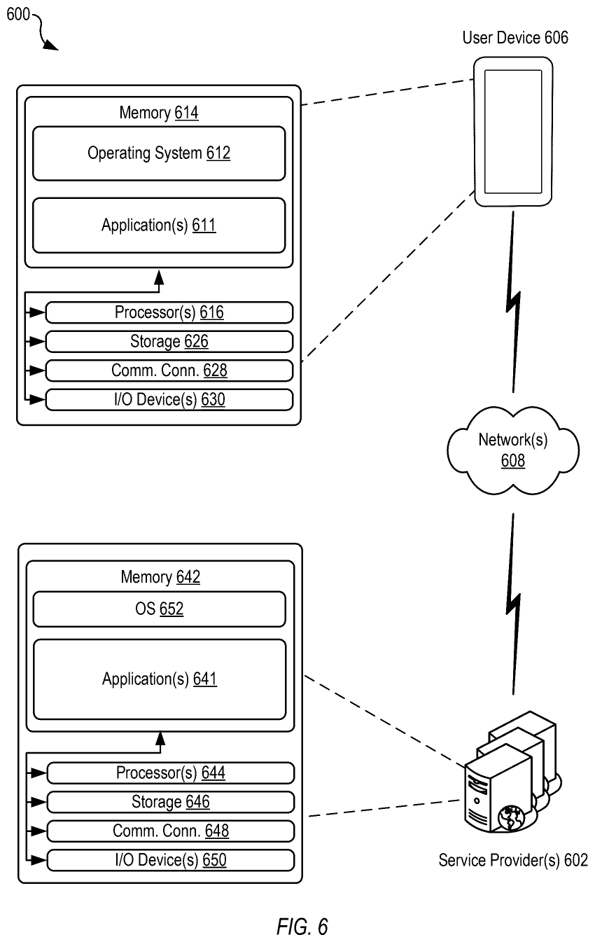

FIG. 6 illustrates an example architecture or environment 600 configured to implement techniques described herein, according to at least one example. The architecture 600 includes a user device 606 (e.g., devices 102, 104, 106, 108) and a service provider computer 602 (e.g., server 130). In some examples, the example architecture 600 may further be configured to enable the user device 606 and the service provider computer 602 to share information. In some examples, the devices may be connected via one or more networks 608 (e.g., via Bluetooth, WiFi, the Internet). In some examples, the service provider computer 602 may be configured to implement at least some of the techniques described herein with reference to the user device 606 and vice versa.

In some examples, the networks 608 may include any one or a combination of many different types of networks, such as cable networks, the Internet, wireless networks, cellular networks, satellite networks, other private and/or public networks, or any combination thereof. While the illustrated example represents the user device 606 accessing the service provider computer 602 via the networks 608, the described techniques may equally apply in instances where the user device 606 interacts with the service provider computer 602 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 606 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 606 may be in communication with the service provider computer 602 via the network 608, or via other network connections.

In one illustrative configuration, the user device 606 may include at least one memory 614 and one or more processing units (or processor(s)) 616. The processor(s) 616 may be implemented as appropriate in hardware, computer-executable instructions, firmware, or combinations thereof. Computer-executable instructions or firmware implementations of the processor(s) 616 may include computer-executable or machine-executable instructions written in any suitable programming language to perform the various functions described. The user device 606 may also include geo-location devices (e.g., a global positioning system (GPS) device or the like) for providing and/or recording geographic location information associated with the user device 606. In some examples, the processors 616 may include a GPU and a CPU.

The memory 614 may store program instructions that are loadable and executable on the processor(s) 616, as well as data generated during the execution of these programs. Depending on the configuration and type of the user device 606, the memory 614 may be volatile (such as random access memory (RAM)) and/or non-volatile (such as read-only memory (ROM), flash memory). The user device 606 may also include additional removable storage and/or non-removable storage 626 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 614 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 614 and the additional storage 626, both removable and non-removable, are all examples of non-transitory computer-readable storage media. For example, non-transitory computer-readable storage media may include volatile or non-volatile, removable, or non-removable media implemented in any method or technology for storage of information such as computer-readable instructions, data structures, program modules, or other data. The memory 614 and the additional storage 626 are both examples of non-transitory computer-storage media. Additional types of computer-storage media that may be present in the user device 606 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 606. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 606 may also contain communications connection(s) 628 that allow the user device 606 to communicate with a data store, another computing device or server, user terminals, and/or other devices via the network 608. The user device 606 may also include I/O device(s) 630, such as a keyboard, a mouse, a pen, a voice input device, a touch screen input device, a display, speakers, and a printer.

Turning to the contents of the memory 614 in more detail, the memory 614 may include an operating system 612 and/or one or more application programs or services for implementing the features disclosed herein such as applications 611 (e.g., device location module on a user device corresponding to device location services). Applications 611 (e.g., device location module on a user device corresponding to device location services) can perform some or all the techniques (or corresponding techniques) as described with reference to the processes 300, 500. Similarly, at least some techniques described with reference to the service provider computer 602 may be performed by the user device 606.

The service provider computer 602 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 602 may be in communication with the user device 606 via the network 608, or via other network connections.

In one illustrative configuration, the service provider computer 602 may include at least one memory 642 and one or more processing units (or processor(s)) 644. The processor(s) 644 may be implemented as appropriate in hardware, computer-executable instructions, firmware, or combinations thereof. Computer-executable instructions or firmware implementations of the processor(s) 644 may include computer-executable or machine-executable instructions written in any suitable programming language to perform the various functions described.

The memory 642 may store program instructions that are loadable and executable on the processor(s) 644, as well as data generated during the execution of these programs. Depending on the configuration and type of service provider computer 602, the memory 642 may be volatile (such as RAM) and/or non-volatile (such as ROM and flash memory). The service provider computer 602 may also include additional removable storage and/or non-removable storage 646 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 642 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 642 and the additional storage 646, both removable and non-removable, are both additional examples of non-transitory computer-readable storage media.

The service provider computer 602 may also contain communications connection(s) 648 that allow the service provider computer 602 to communicate with a data store, another computing device or server, user terminals, and/or other devices via the network 608. The service provider computer 602 may also include I/O device(s) 650, such as a keyboard, a mouse, a pen, a voice input device, a touch input device, a display, speakers, and a printer.

Turning to the contents of the memory 642 in more detail, the memory 642 may include an operating system 652 and/or one or more application programs 641 or services for implementing the features disclosed herein. Applications 641 (e.g., the device location services) can perform some or all of the techniques (or corresponding techniques) as described with reference to the processes 300, 500.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user's personal health record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's experience with multi-factor authentication services. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method, comprising:
receiving, by a service running on one or more server devices from a set of one or more user devices associated with a profile, respective user device tracking information for each device of the set of one or more user devices, the set of one or more user devices including trusted devices and untrusted devices;
receiving, by the service, a first signal indicative that a critical operation associated with the profile is being requested;
receiving, by the service from a first user device of the set of one or more user devices, a request for respective user device tracking information for other devices of the set of one or more user devices;
determining, by the service, whether the first user device is untrusted; and
in accordance with a determination that the first user device is untrusted, determining, by the service, to not transmit respective user device tracking information for other devices to the first user device.

2. The computer-implemented method of claim 1, wherein determining whether the first user device is untrusted includes:
determining, by the service, whether the request originates from a web browser on the first user device; and
in accordance with determining the request originates from the web browser, determining, by the service, the first user device is untrusted.

3. The computer-implemented method of claim 2, wherein determining whether the first user device is untrusted is based at least in part on an indication that the first user device did not receive biometric authentication in response to a biometric confirmation request from the service, and wherein determining whether the first user device is untrusted includes:
transmitting, by the service to the first user device, the biometric confirmation request, the first user device configured to request biometric authentication in response to the biometric confirmation request; and
receiving, by the service from the first user device, the indication that the first user device did not receive biometric authentication in response to the biometric confirmation request.

4. The computer-implemented method of claim 2, wherein the request for respective user device tracking information for other devices includes an indication that biometric confirmation was not received by the first user device in association with the request for respective user device tracking information for other devices, and wherein determining whether the first user device is untrusted is based at least in part on the indication.

5. The computer-implemented method of claim 1, further comprising:
determining, by the service, whether the first user device is trusted; and
in accordance with determining the first user device is trusted, transmitting, by the service to the first user device, respective user device tracking information for other devices of the set of one or more user devices.

6. The computer-implemented method of claim 5, wherein determining whether the first user device is trusted is based at least in part on an indication that the first user device received biometric authentication in response to a biometric confirmation request from the service, and wherein determining whether the first user device is trusted includes:
transmitting, by the service to the first user device, the biometric confirmation request, the first user device configured to request biometric authentication in response to the biometric confirmation request; and
receiving, by the service from the first user device, the indication that the first user device received biometric authentication in response to the biometric confirmation request.

7. The computer-implemented method of claim 5, wherein the request for respective user device tracking information for other devices of the set of one or more user devices includes a biometric confirmation that the first user device requested and received biometric authentication in association with the request for respective user device tracking information for other devices, and wherein determining whether the first user device is trusted is based at least in part on the biometric confirmation.

8. The computer-implemented method of claim 1, further comprising:
receiving, by the service, a second request for respective user device tracking information for the set of one or more user devices;
determining, by the service, whether the second request originates from a web browser; and
in accordance with determining the second request originates from the web browser, transmitting, by the service to the first user device, an indication that the respective user device tracking information for other devices is unknown or unavailable based at least in part on the first signal.

9. The computer-implemented method of claim 1, wherein the critical operation includes altering a security feature associated with the profile.

10. The computer-implemented method of claim 1, wherein the critical operation includes accessing financial information associated with the profile.

11. The computer-implemented method of claim 1, wherein the critical operation includes marking a second user device as a lost device.

12. The computer-implemented method of claim 1, further comprising:
receiving, by the service, a second signal indicative that the critical operation is completed;
receiving, by the service from the first user device, a request for respective user device tracking information for other devices of the set of one or more user devices; and
transmitting, by the service to the first user device, respective user device tracking information for other devices of the set of one or more user devices based at least in part on the second signal.

13. The computer-implemented method of claim 1, wherein the respective user device tracking information for the set of one or more devices is accessible by a web browser.

14. A system, comprising:
a storage medium configured to store computer-executable instructions; and
one or more processors coupled to the storage medium and configured to execute computer-executable instructions to at least:
receive, from a set of one or more user devices associated with a profile, respective user device tracking information for each device of the set of one or more user devices, the set of one or more user devices including trusted devices and untrusted devices;
receive a first signal indicative that a critical operation associated with the profile is being requested;
receive, from a first user device of the set of one or more user devices, a request for respective user device tracking information for other devices of the one or more user devices;
determine whether the first user device is untrusted; and
in accordance with a determination that the first user device is untrusted, determine to not transmit respective user device tracking information for other devices to the first user device.

15. The system of claim 14, wherein determining whether the first user device is untrusted includes:
determining whether the request originates from a web browser on the first user device; and
in accordance with determining the request originates from the web browser, determining the first user device is untrusted.

16. The system of claim 15, wherein determining whether the first user device is untrusted is based at least in part on an indication that the first user device did not receive biometric authentication in response to a biometric confirmation request, and wherein determining whether the first user device is untrusted includes:
transmitting, to the first user device, the biometric confirmation request, the first user device configured to request biometric authentication in response to the biometric confirmation request; and
receiving, from the first user device, the indication that the first user device did not receive biometric authentication in response to the biometric confirmation request.

17. The system of claim 15, wherein the request for respective user device tracking information for other devices includes an indication that biometric confirmation was not received by the first user device in association with the request for respective user device tracking information for other devices, and wherein determining whether the first user device is untrusted is based at least in part on the indication.

18. A non-transitory computer-readable storage medium having stored thereon program instructions that, when executed by one or more processors of a computer system, cause the computer system to perform operations, comprising:
receiving, from a set of one or more user devices associated with a profile, respective user device tracking information for each device of the set of one or more user devices, the set of one or more user devices including trusted devices and untrusted devices;
receiving a first signal indicative that a critical operation associated with the profile is being requested;
receiving, from a first user device of the set of one or more user devices, a request for respective user device tracking information for other devices of the one or more user devices;
determining whether the first user device is untrusted; and
in accordance with a determination that the first user device is untrusted, determining to not transmit respective user device tracking information for other devices to the first user device.

19. The non-transitory computer-readable storage medium of claim 18, storing further program instructions that, when executed by one or more processors of a computer system, cause the computer system to perform further operations, comprising:
determining whether the first user device is trusted; and
in accordance with determining the first user device is trusted, transmitting, to the first user device, respective user device tracking information for other devices of the one or more user devices.

20. The non-transitory computer-readable storage medium of claim 19, wherein determining whether the first user device is trusted is based at least in part on an indication that the first user device received biometric authentication in response to a biometric confirmation request, and wherein determining whether the first user device is trusted includes:
transmitting, to the first user device, the biometric confirmation request, the first user device configured to request biometric authentication in response to the biometric confirmation request; and
receiving, from the first user device, the indication that the first user device received biometric authentication in response to the biometric confirmation request.
